(19) United States
(12) Patent Application Publication
(10) Pub. No.: US 2015/0084827 A1
(43) Pub. Date: Mar. 26, 2015

(54) Enhanced Connected Tiled Array Antenna

(71) Applicant: Commonwealth Scientific and Industrial Research Organization, Campbell (AU)

(72) Inventor: Stuart Gifford Hay, Kogarah Bay (AU)

(21) Appl. No.: 14/388,795

(22) PCT Filed: Mar. 28, 2013
(86) PCT No.: PCT/AU2013/000315

§ 371 Date: Sep. 26, 2014

(30) Foreign Application Priority Data
Mar. 29, 2012 (AU) 2012901270

(51) Int. Cl. H01Q 9/04; H01Q 1/50

(52) U.S. Cl. CPC H01Q 9/0407; H01Q 1/50
USPC 343/860

(57) ABSTRACT

An antenna device including: a conductive ground sheet of a substantially planar form; and a series of spaced apart conductive patches arranged substantially in a plane parallel to the conductive ground plane; a series of conductive feed interconnections electromagnetically coupled to the spaced apart array of conductive patches.

### FIELD OF THE INVENTION

The present invention relates to the field of antenna devices and, in particular, discloses an improved form of antenna construction.

### BACKGROUND

Any discussion of the background art throughout the specification should in no way be considered as an admission that such art is widely known or forms part of common general knowledge in the field.

Antenna transmitting and receiving systems can take many forms. One form of system is illustrated in FIG. 1 and is known as a parabolic dish type antenna. The antenna 1 includes a parabolic dish 2 which acts to concentrate or focus signals at a focal point 3 where the transmitter/receiver 3 is located.

Many different types of transmitter/receiver are known. For example, Patent Cooperation Treaty Patent Application: PCT/AU2011/000862 entitled “Reconfigurable Self Complementary Array” discloses one form of “checkerboard array” of transmitter/receivers of a self complementary form suitable for use in many applications. Such a checkerboard array is suitable for many uses including in a large receiver network of transmitter/receivers such as that proposed in the Square Kilometer Array (SKA) project.

The checkerboard array design is illustrated schematically 10 in FIG. 2. The design uses a planar array of electrically conducting squares e.g. 11 forming a tiled-like pattern where the squares are equal in size and orientation and of approximately the same area as the inter-square region. The array design includes electrical circuits (not shown) that connect neighboring squares between pairs of nearest corners.

As illustrated in FIG. 3, the electrical circuits include feed conductors 30 that connect the corners of the squares e.g. 11 to electrical circuits located some distance away toward a groundplane 31 that is parallel to the plane of the squares 11. The conductors of the circuits may pass through holes 32 in the groundplane 31, and may include connections to the groundplane and may include one or more terminals to which other circuits may be connected. The circuits may include amplifiers that amplify signals to be received or transmitted to the array.

A circuit configuration that has been found to be effective is illustrated 40 in FIG. 4, with the square patch being interconnected to an amplifier 42 for output of differential voltages e.g. 43. FIG. 5 illustrates the same arrangement as FIG. 4, with the addition of an outside Balun 51 to provide a differential voltage output.

It is desirable to provide an improved form of tiled array design.

### SUMMARY OF THE INVENTION

It is an object of the present invention to provide an effective form of transmitter and or receiver.

In accordance with an aspect of the present invention, there is provided an antenna device including: a first conductive extended body structure including a first surface; a series of spaced apart conductive patches arranged substantially in the plane of a second surface offset from said first surface; a series of conductive feed interconnections capacitively coupled to the spaced apart array of conductive patches, said conductive feed interconnections being profiled to provide a complementary series inductance to said capacitive coupling so as to thereby improve the impedance matching of the conductive feed and conductive patches.

Preferably, the antenna device operates over a predetermined frequency range and the reactance of the conductive feed and conductive patch interconnection is negative at low operational frequencies and positive at high operational frequencies and zero at an intermediate frequency.

Preferably, the first surface forms one side of a thin sheet. In some embodiments, the conductive feed interconnections are arranged into two sets of orthogonal polarizations for feeding corresponding conductive patches in a polarization orthogonal manner. In some embodiments, the conductive feed interconnections include an elongated portion substantially parallel to the surface of any adjacent conductive patches. Preferably, the feeds from orthogonal polarizations are spaced apart when coupled to the patches.

In some embodiments, the elongated portion includes a capacitive plate portion overlapping the conductive patch to provide controlled capacitive coupling thereto. The capacitive plate portion can comprise an end portion of the conductive feed. In accordance with a further aspect of the present invention, there is provided an antenna device including: a conductive ground sheet of a substantially planar form; and a series of spaced apart conductive patches arranged substantially in a plane parallel to the conductive ground plane; a series of conductive feed interconnections electromagnetically coupled to the spaced apart array of conductive patches. The conductive feed interconnections can include an elongated portion substantially parallel to the plane of the conductive patches. The elongated portion can be in the same plane as the plane of the conductive patches.

The conductive ground sheet preferably can include a series of apertures and the conductive feed interconnections are preferably fed through the apertures. The conductive feed interconnections are preferably surrounded by a shield adjacent the conductive ground sheet. The shield can be conductively interconnected to the ground sheet.

The conductive patches are preferably arranged in a regular array. In one embodiment, the conductive patches are preferably capacitively coupled to the conductive feed interconnections. In other embodiments, the conductive patches and the conductive feed interconnections are preferably separated by a small non conductive gap.

The conductive patches are preferably of a generally square form with rounded corners. In some embodiments, the conductive feeds from the closest electromagnetic coupling with the conductive patches at the corners of the conductive patches. The conductive feeds surround the conductive patches and are preferably generally of an elongated form with the elongation being in a direction radial to the center of a corresponding conductive patch.

In some embodiments, pairs of the feed conductors are preferably shielded by a conductive unit interconnected to the ground sheet in the area adjacent the ground sheet, the conductive unit of a generally boxed form having a slot in one surface thereof between the pairs. In accordance with a further aspect of the present invention, there is provided a method of designing an antenna array device, the device including a first conductive extended body structure including a first surface; a series of spaced apart conductive patches arranged substantially in a second surface offset from the first surface; a series of conductive feed interconnections electromagnetically coupled to the spaced apart array of conductive patches, the method including the step of: providing a conductive patch pattern that increases the conductive patch inductance in comparison with a checkerboard or self complementary array when said antenna array device is operated at frequencies greater than an equivalent wavelength less than the quarter wave distance between the first surface and the second surface.

Preferably, the method also includes increasing the conductive patch inductance through a reduction in size of the patches relative to a checkerboard or self complementary pattern.

Preferably, the conductive patch inductance is increased through the utilisation of a smaller conductive patch and a series of elongated conductive feed interconnections in said second surface.

Preferably, the method also includes increasing the capacitance of the antenna array device when operated at frequencies lower than an equivalent frequency to the wavelength greater than the quarter wave distance between the first surface and the second surface. The capacitance can be increased by the interconnection of a capacitive device between predetermined conductive patches and corresponding conductive feed interconnections.

In accordance with a further aspect of the present invention there is provided a method of suppressing the amount of common mode current in an antenna array device, said device including a first conductive body structure including a first surface; a series of spaced apart conductive patches arranged substantially in a plane of a second surface offset from the first surface; and a series of conductive feed interconnections electromagnetically coupled to the spaced apart array of conductive patches, the method including the step of: suppressing the common mode current by means of shielding the conductive feed interconnections in the vicinity of said first conductive body structure sheet.

Preferably, the shielding includes a conductive shield conductively interconnected to said first conductive body structure. In some embodiments, the conductive feed interconnections are driven in a voltage differential mode.

### BRIEF DESCRIPTION OF THE DRAWINGS

Preferred embodiments of the invention will now be described, by way of example only, with reference to the accompanying drawings in which:

FIG. 1 illustrates a parabolic transmitter/receiver;

FIG. 2 illustrates a plan view of a checkerboard transmitter/receiver;

FIG. 3 illustrates schematically the interconnection of array patches to feed conductors through the ground plane of a checkerboard array;

FIG. 4 illustrates schematically the electrical interconnection of dual single-ended amplifiers to the array patch elements;

FIG. 5 illustrates schematically a similar arrangement to FIG. 4 with an output side Balun;

FIG. 6 illustrates a plan view of the modified geometry of the array of the preferred embodiment;

FIG. 7 illustrates a side perspective view of a portion of the array of FIG. 6, showing patches, feed conductors and ground plane;

FIG. 8 is a first side sectional view of one form of arrangement of feed conductors and patches;

FIG. 9 is a second side sectional view of an alternative arrangement of feed conductors and patches;

FIG. 10 illustrates a plan view showing capacitors interconnected across the patch, feed conductor interface;

FIG. 11 illustrates simulated array impedances for various tiled designs;

FIG. 12 illustrates the array impedance with capacitors between the feed conductors and patches;

FIG. 13 illustrates the utilization of conductive tubes around the feed conductors;

FIG. 14 illustrates the results of utilization of conductive tubes around feed conductors;

FIG. 15 illustrates similar results to FIG. 14, however, the conductive tubes have been removed;

FIG. 16 illustrates the impedance of a 5×4 array with tubes around the feed conductors;

FIG. 17 illustrates a further modification of surrounding the feed conductors with a slotted groundplane extension;

FIG. 18 illustrates a graph of the array and low noise amplifiers minimum noise impedances; and

FIG. 19 illustrates a graph of noise temperatures for a revised tiled array;

FIG. 20 illustrates schematically a self complementary array structure;

FIG. 21 illustrates the complementary form of the array of FIG. 20;

FIG. 22 illustrates the equivalent circuit of the self-complementary array;

FIG. 23 illustrates an approximate equivalent circuit of a self complementary array and groundplane;

FIG. 24 illustrates schematically an approximate equivalent circuit consisting of load impedance and antenna impedance;

FIG. 25 illustrates an antenna impedance Z_{A} plotted on a Smith chart where the reference impedance at the centre of the chart is Z₀. Also shown in the modified antenna impedance Z_{AA} obtained by the series combination of Z_{A} and the capacitance C1=0.9 pF and inductance L1=25 nH;

FIG. 26 illustrates an equivalent circuit for an array antenna with feed conductor transmission lines of length d and series capacitive and inductive circuit elements inserted between the self complementary array and the load circuits;

FIG. 27 illustrates the modified antenna impedance Z_{AA} plotted on a Smith chart where the reference impedance at the centre of the chart is Z₀. Also shown is the impedance Z_{BB} obtained by the series combination of Z_{AA} and the feed conductor transmission lines of length d and characteristic impedance Z₀;

FIG. 28 illustrates a Smith chart of the effective antenna impedance Z_{B} plotted where the reference impedance at the centre of the chart is Z₀. The effective antenna impedance Z_{B} is the series combination of Z_{BB} and the capacitance C2=1.2 pF and inductance L2=25 nH;

FIG. 29 illustrates the reflection coefficient corresponding to the effective antenna impedance of FIG. 28;

FIG. 30 illustrates an alternative arrangement having low loss series inductance formed in the ground plane by means of a series of slots;

FIG. 31 illustrates a schematic side perspective view of an alternative form of array element;

FIG. 32 illustrates a top plan view of the arrangement of FIG. 31; and

FIG. 33 illustrates a side sectional view through the arrangement of FIG. 31.

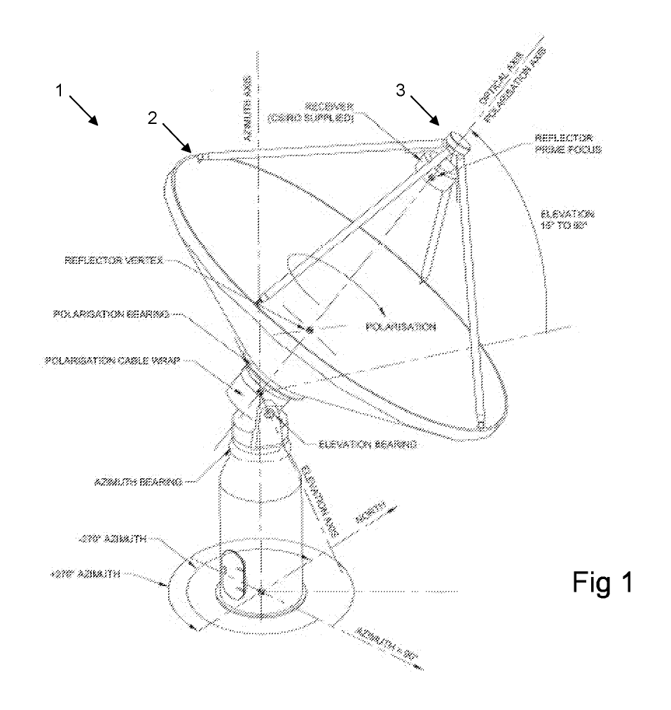

### DETAILED DESCRIPTION

In the preferred embodiments there is provided a modified form of self complementary antenna tiled array design that leads to improved performance parameters.

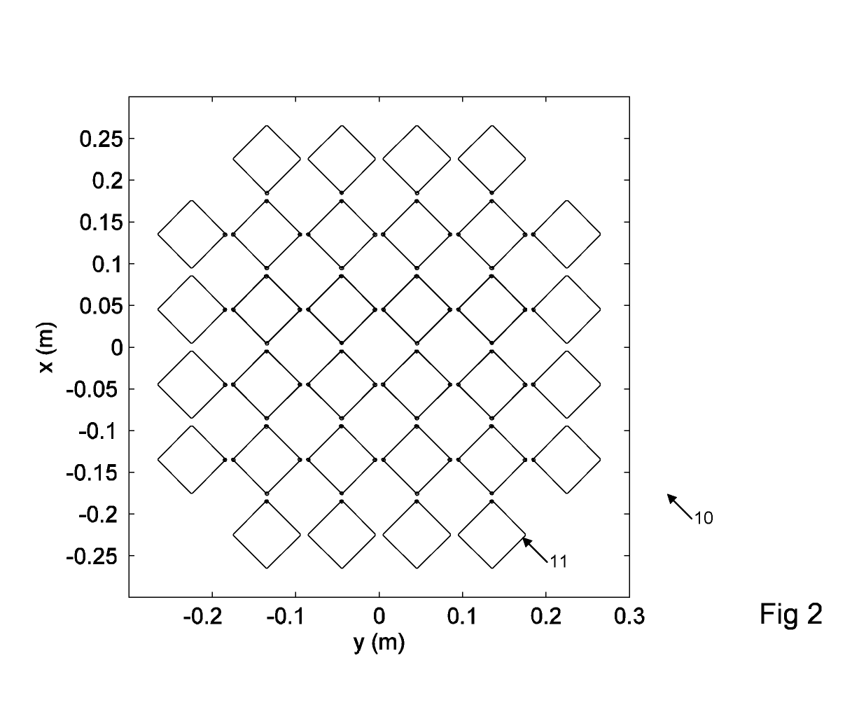

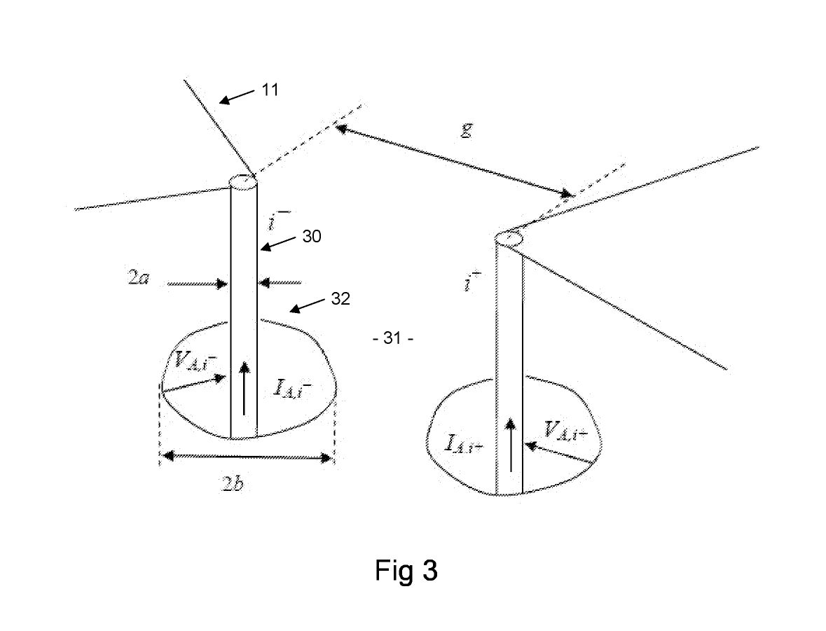

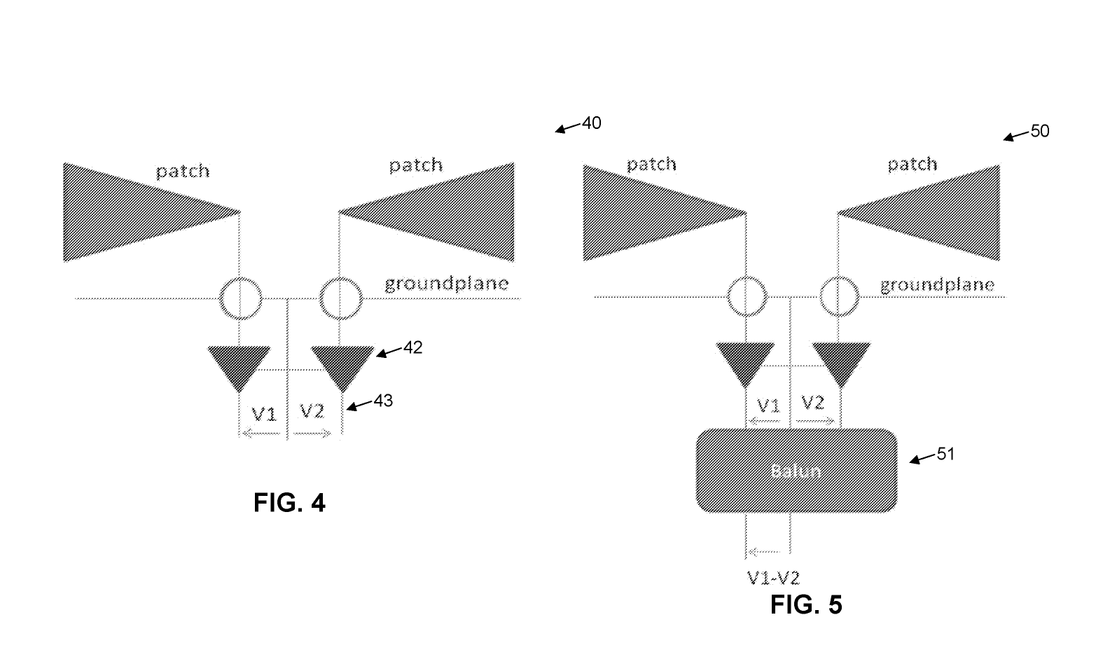

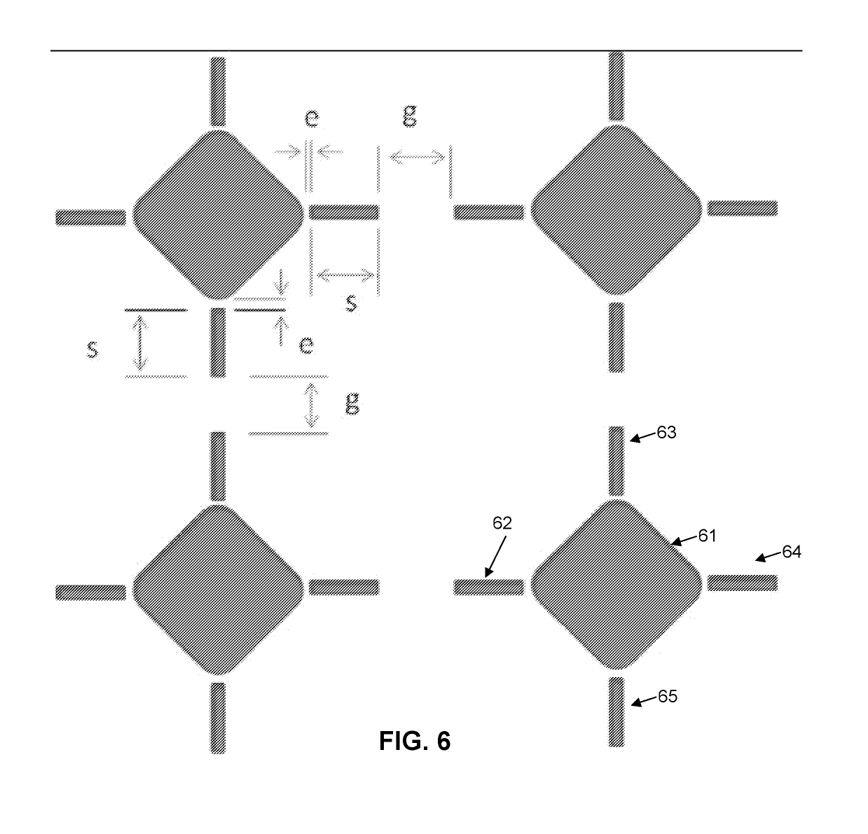

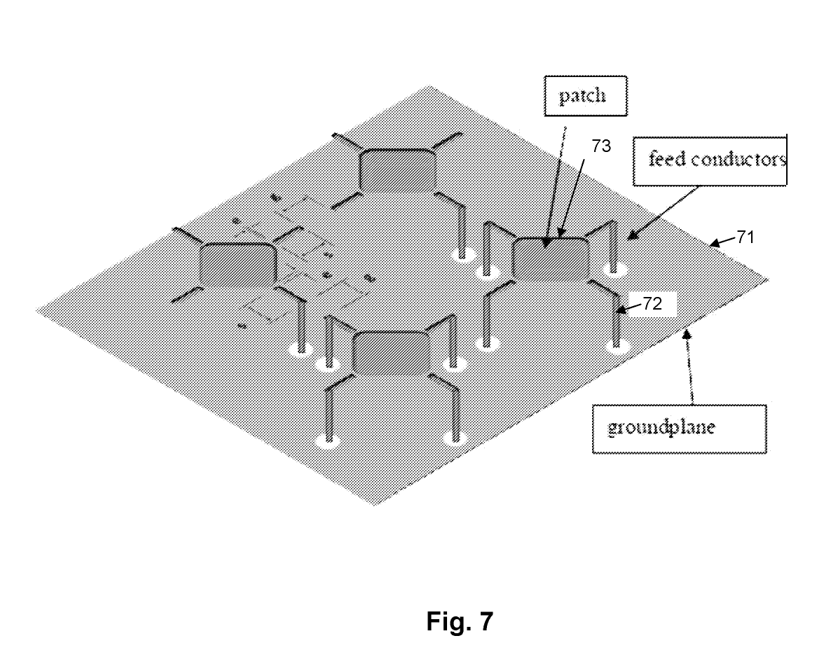

As illustrated initially in FIG. 6 in a plan view, the purely tiled design of FIG. 2 is modified, with the tiles being replaced with a ‘star’ arrangement, including a central portion 61 and a series of outer bar portions 62-65 which are separated from the central portion my means of a small gap. The central portion 61 is substantially square with rounded edges. FIG. 7 illustrates a side view of the patches 73, with feed conductors 72 projecting through ground plane 71.

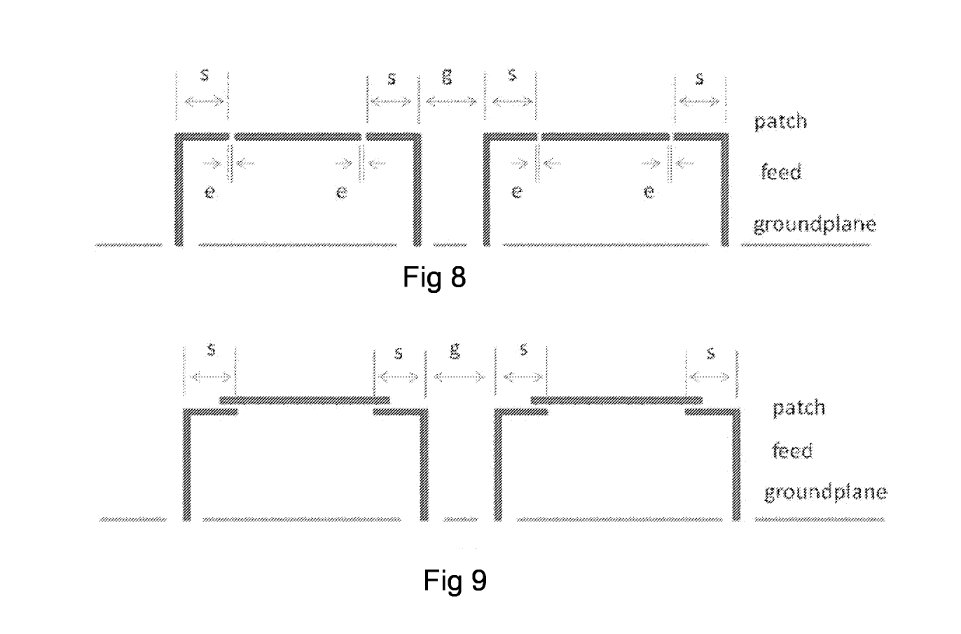

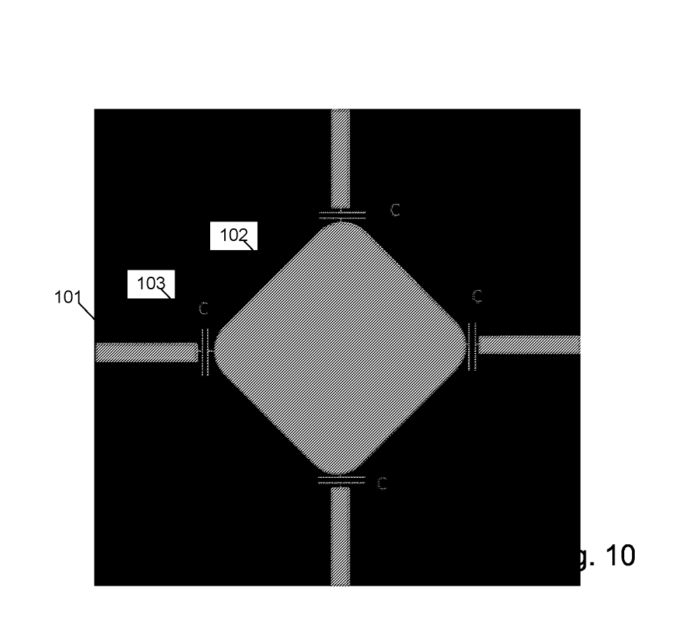

As shown in FIG. 8, the patch components can be separated from the feed conductors by a small gap but remain co-planar therewith. Alternatively, as shown in FIG. 9, the patch can be offset from the feed conductors which are displaced in a parallel plane. In this latter case, the conducting parts may be overlapping in projection onto a common parallel plane.

As shown in FIG. 10, the edges between feed conductors 101 and patch 102 may be connected by electrical circuits such as capacitors.

The modifications to the tiled array design can be used to change the impedance of the array in a way that improves the impedance matching of the array and the electrical circuits connecting the array elements. Improving the impedance match between the array and the circuits can increase the array performance in terms of received or transmitted signal power transfer between the array and the circuits or the noise contribution from low-noise amplifiers in these circuits when the array is operated in reception. The improvement in impedance matching may be achieved over a range of frequencies increasing the useful bandwidth of the array.

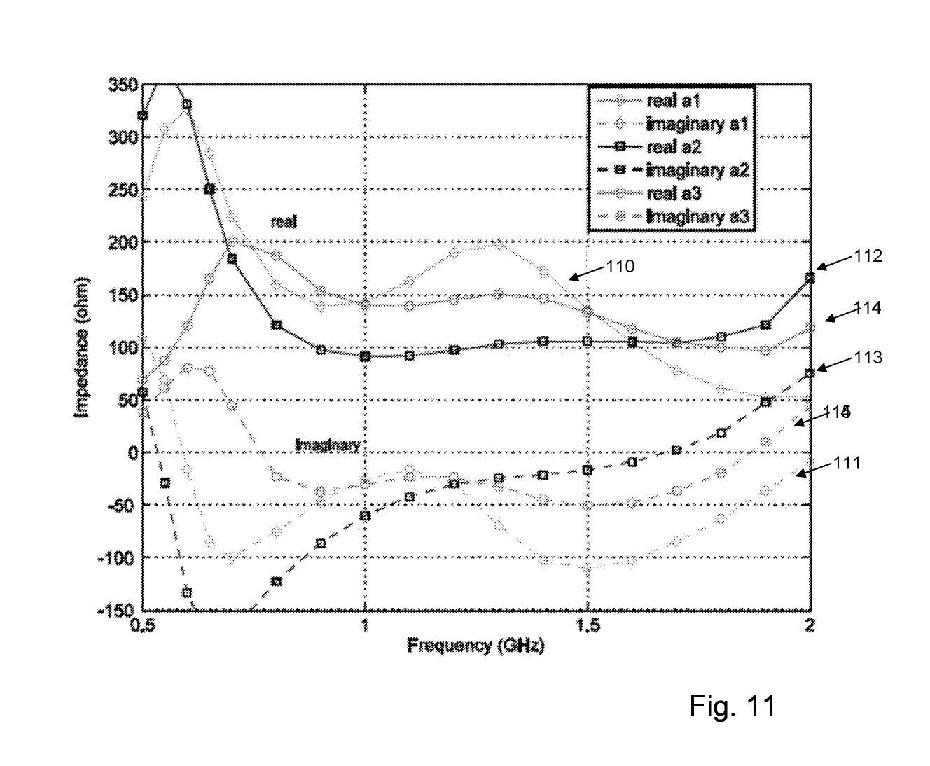

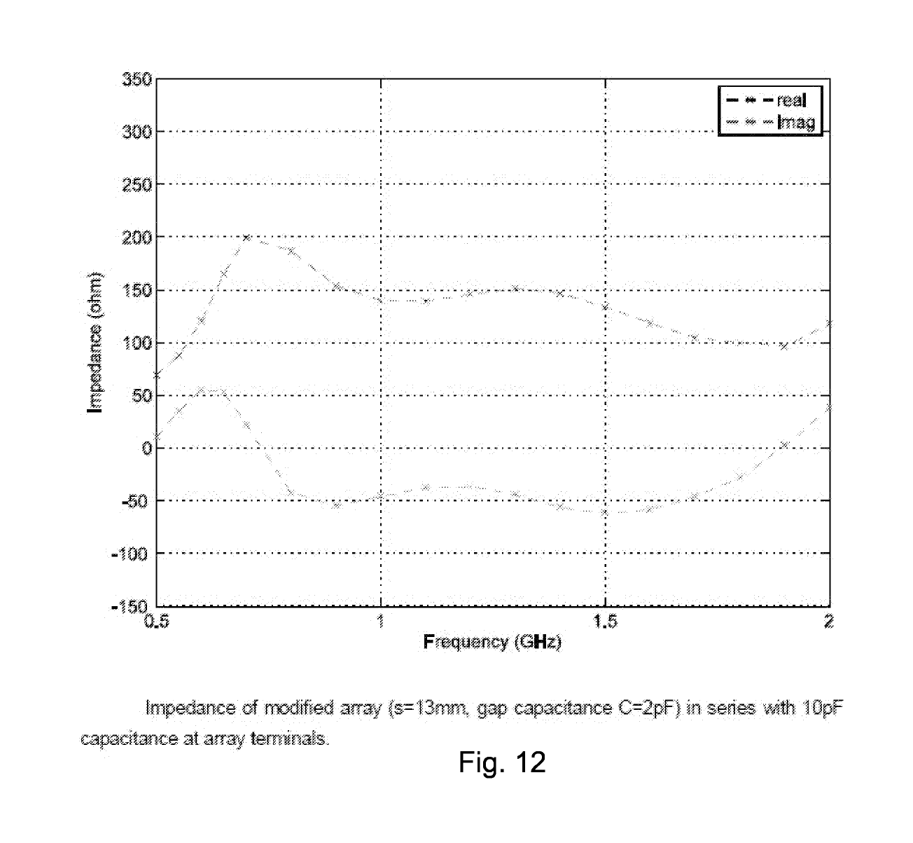

FIG. 11 shows modeling results that illustrate the possible changes to the array impedance.

The initial curves 110 and 111 represent the original checkerboard array of the aforementioned specification. The real and imaginary parts of the impedance vary with frequency in a way that may limit impedance matching to practical circuits connecting the array elements.

The second series of curves 112, 113 are the real and imaginary impedance components for the modified array with reduced patch size but no gaps. It is evident that the modification to the patch geometry has resulted in a substantial change in the array impedance at high frequency. These changes include increase in the real part and decrease the magnitude of the imaginary part of the impedance, and a decrease in the variation of the impedance with frequency at high frequencies.

The third series of curves 114, 115 curves show the results for the modified array with the addition of the gaps and insertion of a 2 pF circuit capacitor between the gaps. As illustrated, the capacitive gaps can be used to change the array impedance at low frequency. It can be seen that the two modifications can be used together to change the array impedance at low and high frequency giving a closer approximation to a constant real impedance over an increased frequency range.

Further improvement of the impedance matching may be obtained by coupling the patch array to the driving circuits via series capacitors at the array terminals at the groundplane. FIG. 9 illustrates impedance of the modified array (s=13 mm, gap capacitance C=2 pF) in series with 10 pF capacitance at the array terminals. This impedance is the single-ended active impedance between the array feed conductors and the groundplane and is approximately equal to 150 ohms over a frequency range of more than 3:1.

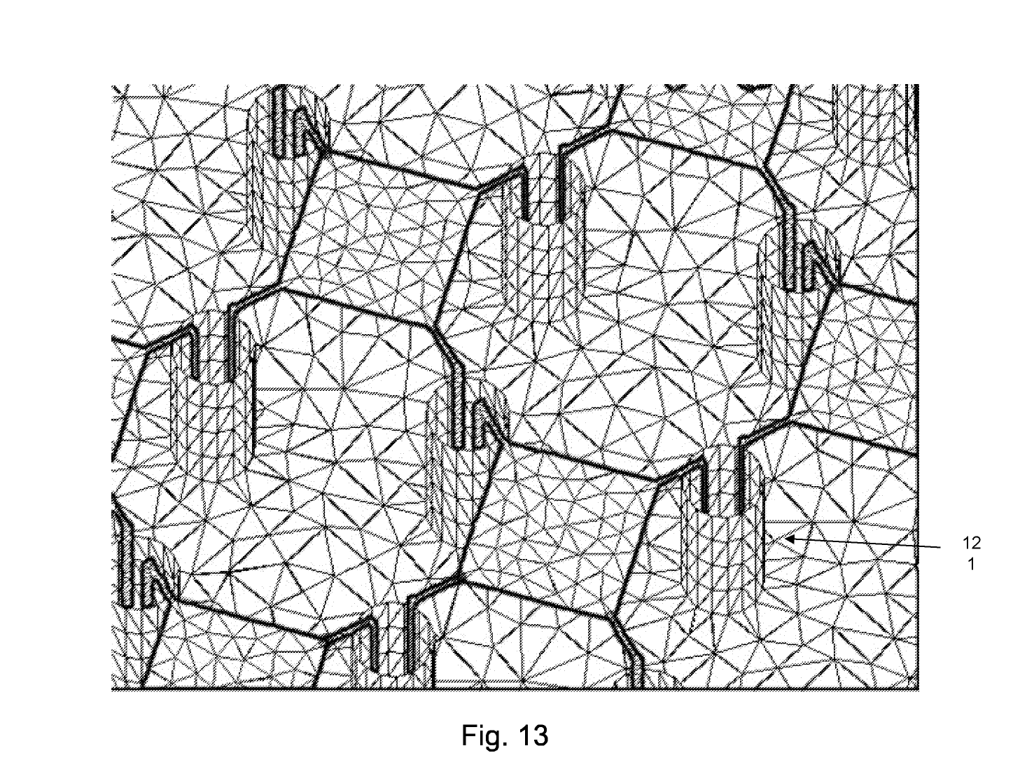

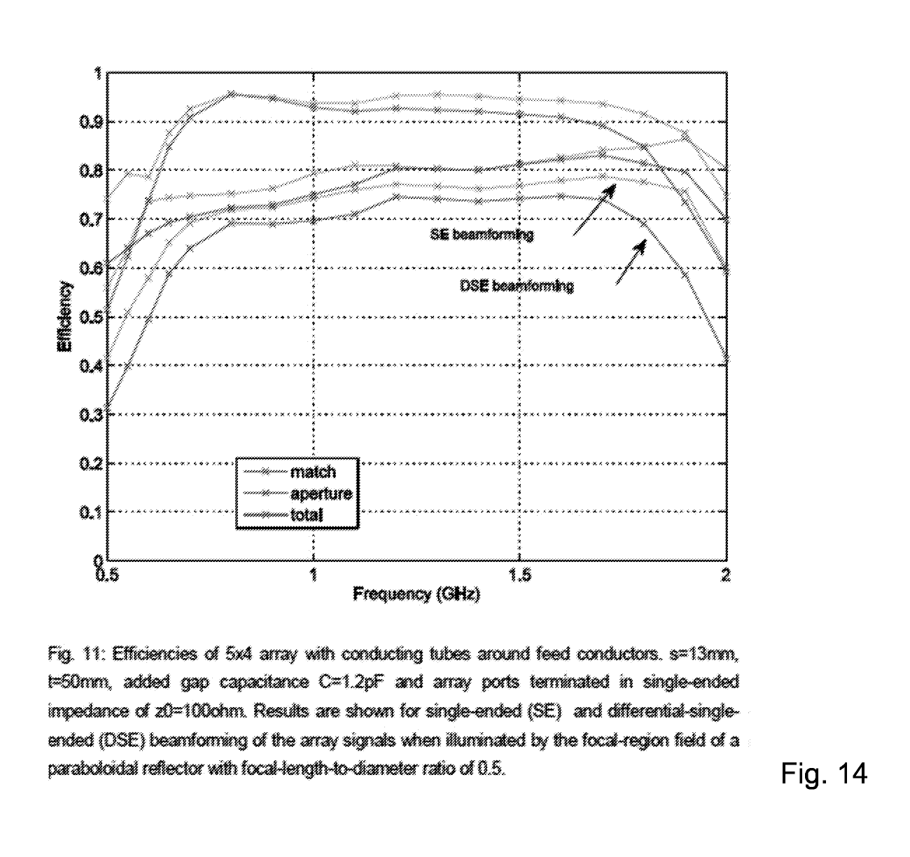

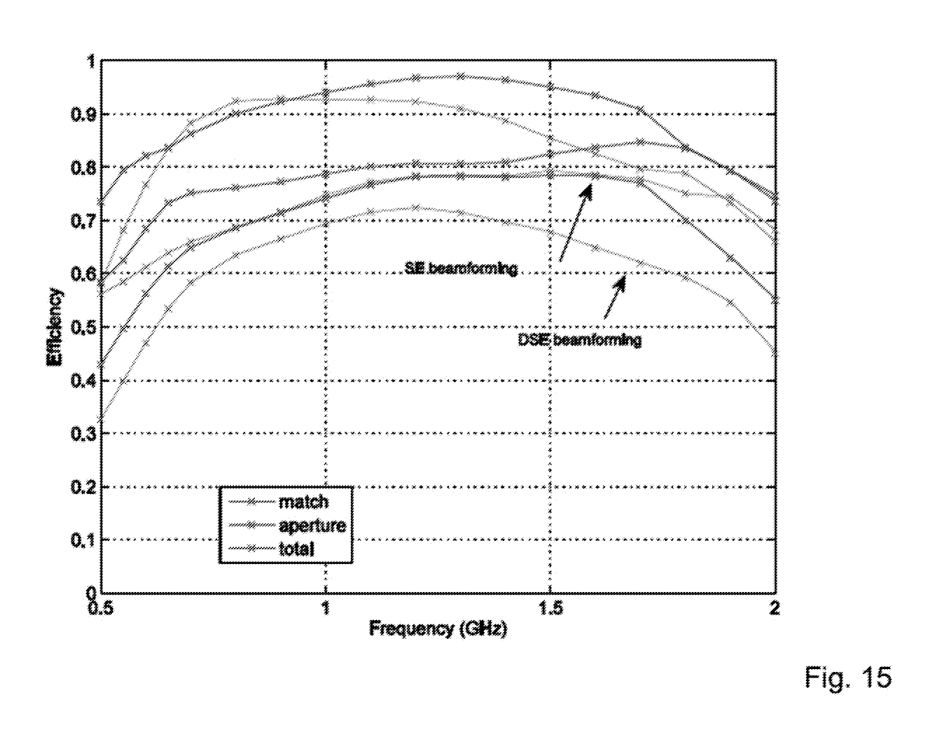

An optional further modification to the array is illustrated in the FEM plot of FIG. 13. Here a conducting tube 121 connected to the groundplane partly surrounds the two feed conductors and provides shielding for the connecting nearest-pair patch corners. This modification may be used to increase the signal strength and signal-to-noise ratio particularly when the connecting circuit configuration shown in FIG. 6 is used and the individual differential voltage outputs v1-v2 of these circuits are linearly combined in a beamformer. This configuration is referred to as differential-single-ended (DSE) beamforming and the increase in signal and signal-to-noise ratio occurs in the beamformed signal. Modeling results illustrating the increase in signal strength can be seen by comparing the signal power transfer efficiencies shown in FIGS. 14 and 15. The shielding acts to suppress the common mode current or enhances the differential mode current of the conductive surrounded feed interconnections.

FIG. 14 illustrates the efficiencies of 5×4 tiled array with conducting tubes around feed conductors (s=13 mm, t=50 mm, added gap capacitance C=1.2 pF and array ports terminated in single-ended impedance of z0=100 ohm). Results are shown for single-ended (SE) and differential-single-ended (DSE) beamforming of the array signals when illuminated by the focal-region field of a paraboloidal reflector with focal-length-to-diameter ratio of 0.5. FIG. 15 illustrates similar results for a 5×4 array without inclusion of conducting tubes around the feed conductors. It can be seen that the addition of the tubes increases the DSE beamformed signal power, particularly at high frequency.

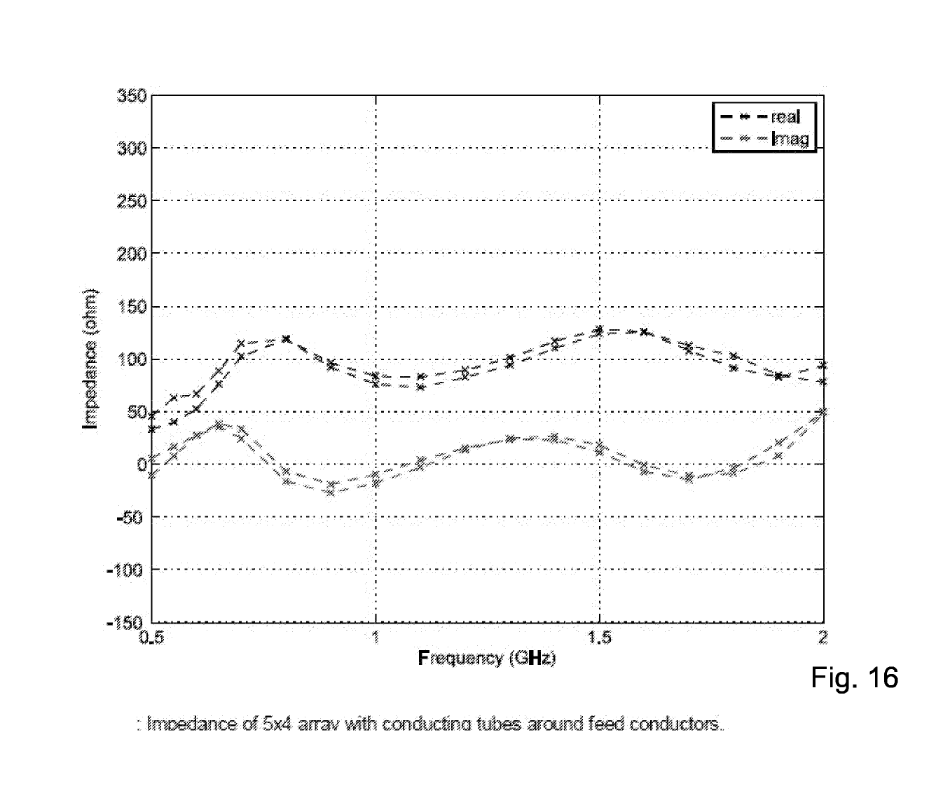

A second use of this modification may be to change the array impedance. FIG. 16 illustrates a general decrease in the magnitude of array impedance giving a single-ended impedance of approximately 100 ohm over a frequency range of more than 3:1 when shielding tubes are used.

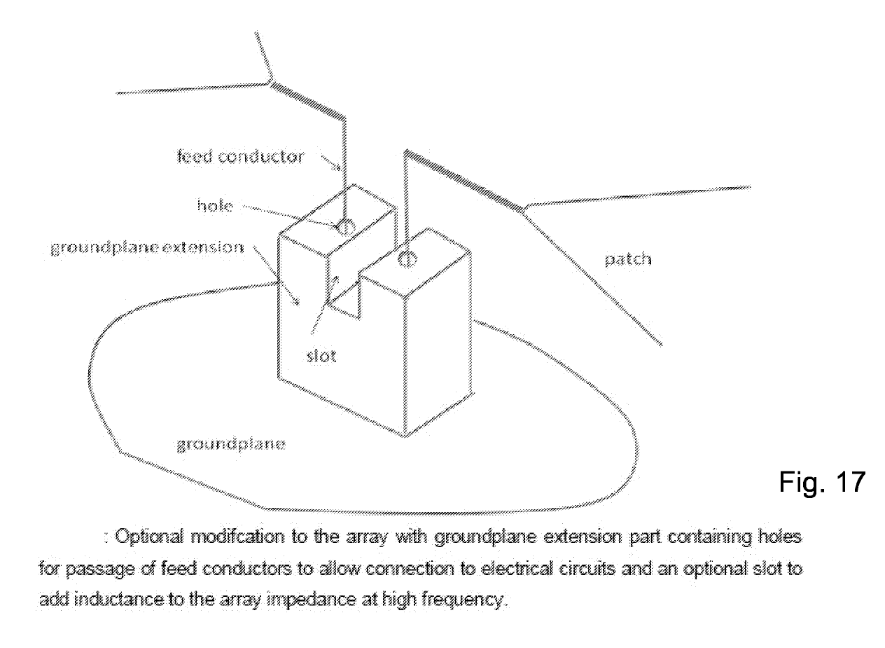

Another optional modification to the array is illustrated in FIG. 17. In some implementations it may be useful to extend, in the direction of the plane of the patch array, the conducting surface of the groundplane containing the holes through which the array feed conductors pass. In this case the conducting surface connected to the groundplane may include a slot in the region between the feed conductors. This slot may be used to change the array impedance, adding series inductance at high frequency, giving greater flexibility in impedance matching the array to practical connecting circuits.

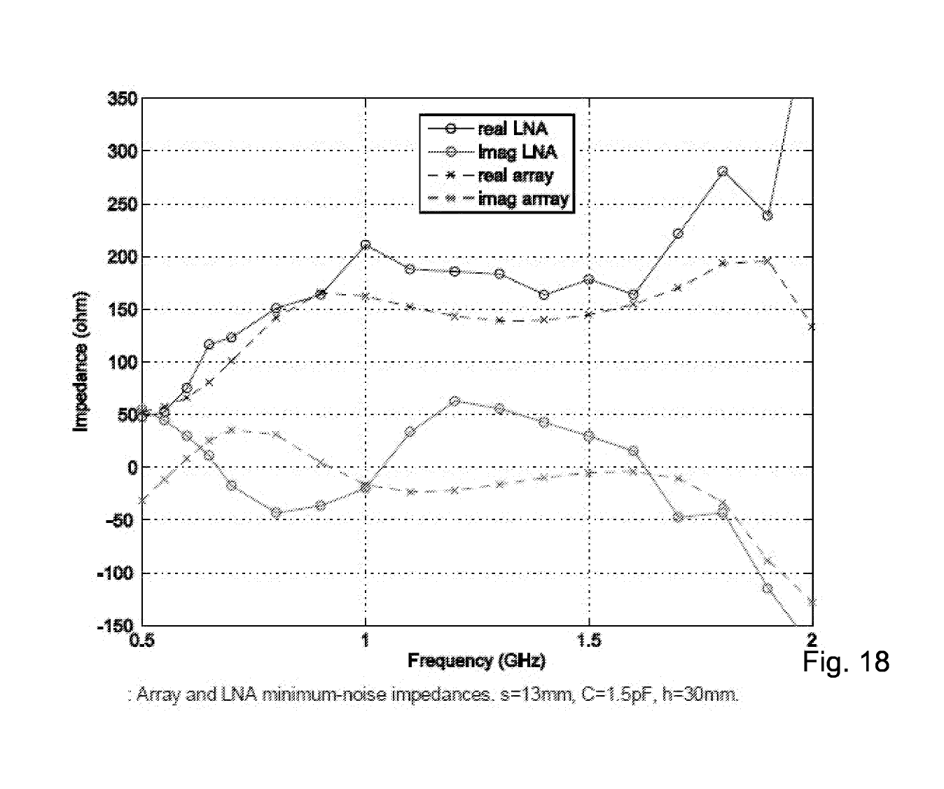

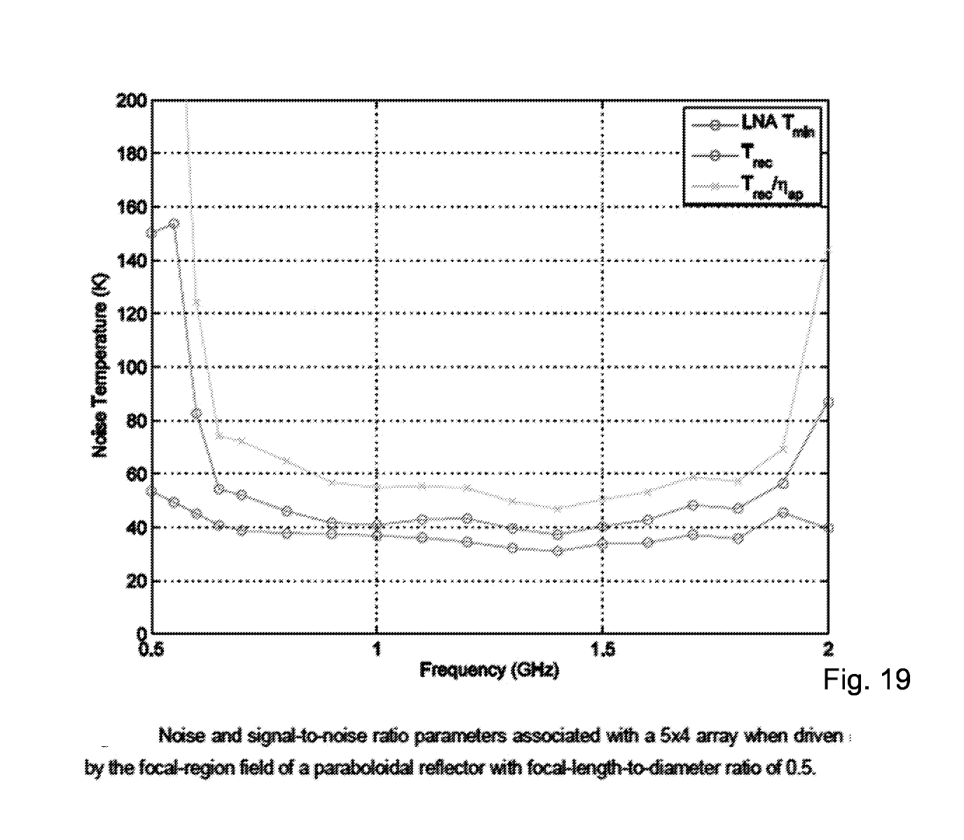

The flexibility and performance that may be obtained using combinations of such modifications to the array is illustrated in FIG. 18 and FIG. 19. FIG. 18 shows calculated impedance matching of a 5×4 array to a practical low-noise amplifier (LNA) circuit. The LNA is of the form shown in FIG. 5. The multiport LNA noise and signal impedances have been estimated from measurements on individual LNA circuits. FIG. 19 shows the minimum noise temperature of the LNA. FIG. 19 also shows the noise and signal-to-noise ratio parameters of the combined array and LNA system. These parameters are the receiver noise temperature (Trec) and the signal-to-noise ratio parameter (Trec/aperture efficiency) associated with the DSE beamformed signal of the array. Greater signal-to-noise ratios can be expected with a larger array.

The design of the embodiments therefore provides an increased frequency range with good impedance match of the array and the electrical circuits connecting the array elements. When receiving, good impedance matching implies high sensitivity or signal-to-noise ratio, particularly when the noise is dominated by the contribution from low-noise amplifiers in the connecting circuits. An associated advantage particularly for low-noise receiving applications is that the introduced circuit matching elements can all be low-loss capacitors. Inductor circuit elements, which typically have relatively high loss, are not required. In the improved array design, inductive effects are realized with low-loss modifications to the conducting surfaces of the array.

Another advantage of the preferred embodiments is increased efficiency when DSE beamforming of the array signals is applied. This also implies decreased equivalent system noise temperature in receiving applications since the definition of equivalent noise temperature includes power transfer efficiency. The increased power transfer into the differential mode implies decreased power in the associated common-mode component that is not beamformed in the DSE configuration. The DSE configuration is very important in many applications. Compared to the full SE beamforming, the DSE configuration halves the cost of signal digitization and digital beamforming.

The modified tiled arrangement described has particular application in the fields of Astronomy, Communications, Health and Security.

### First Embodiment Analysis

Whilst not wishing to be bound by theory, the first embodiment is considered to have a number of advantageous impedance characteristics. These can be highlighted by examination of an approximate equivalent circuit representation of the enhanced tiled array

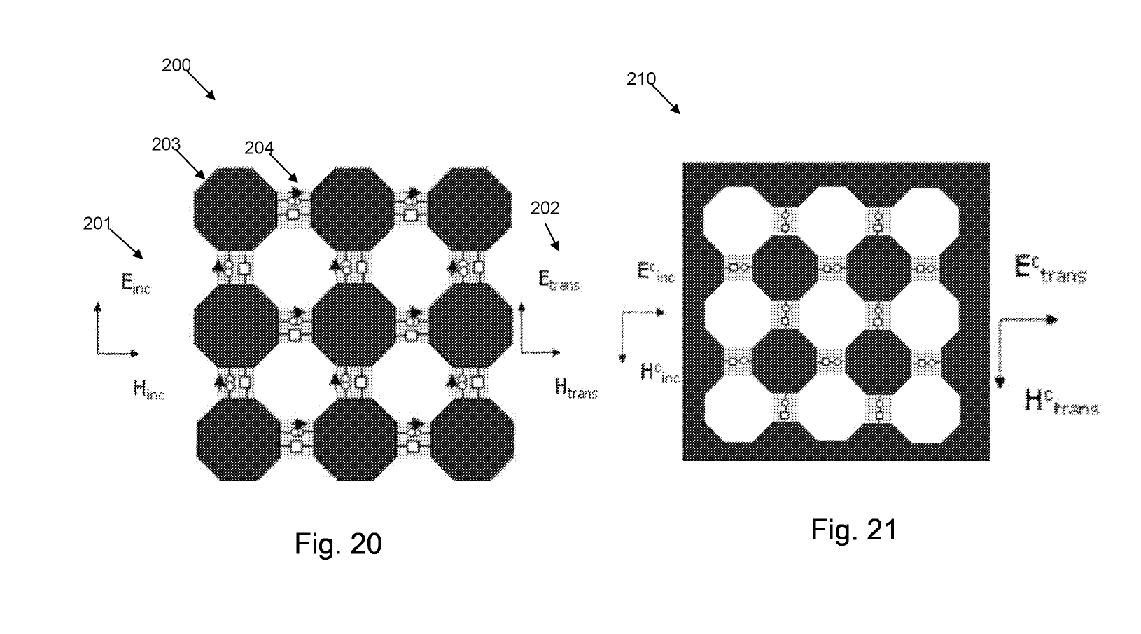

FIG. 20 illustrates a number of contiguous elements of a planar self-complementary array antenna 200 and the electric (E) and magnetic (H) field vectors of incident 201 and transmitted 202 plane waves propagating in a direction normal to the plane of the array. The array is modeled as a distribution of surface impedance Z(x,y) (ohms per square) as a function of Cartesian coordinates (x,y) of points in the plane of the array.

The distribution of surface impedance consists of perfect conductor e.g. 203, free space and feed region (204), the respective surface impedances being zero, infinite and Z₀/2 ohms per square, where Z₀=376.7 ohms is the wave impedance of free space.

The self-complementary property of the array can be seen by examining the complementary array and field configuration illustrated 210 in FIG. 21. The complementary array is defined by the surface impedance Z_{c}(x,y) such that the product Z(x,y) Z_{c}(x,y) is equal to (Z₀/2) squared, and the complementary field is defined as the original field but with the field vectors rotated around the direction of propagation by 90 degrees. The original array 200 in FIG. 20 is self-complementary because it maps onto its complement when rotated by 90 degrees around the centre of any of the grey feed regions. For any such array the feed region impedance is Z₀/2 ohms per square. A good discussion of this electromagnetic form of Babinet's Principle is given by Senior and Volakis (IEE Electromagnetic Waves Series, 41, 1995).

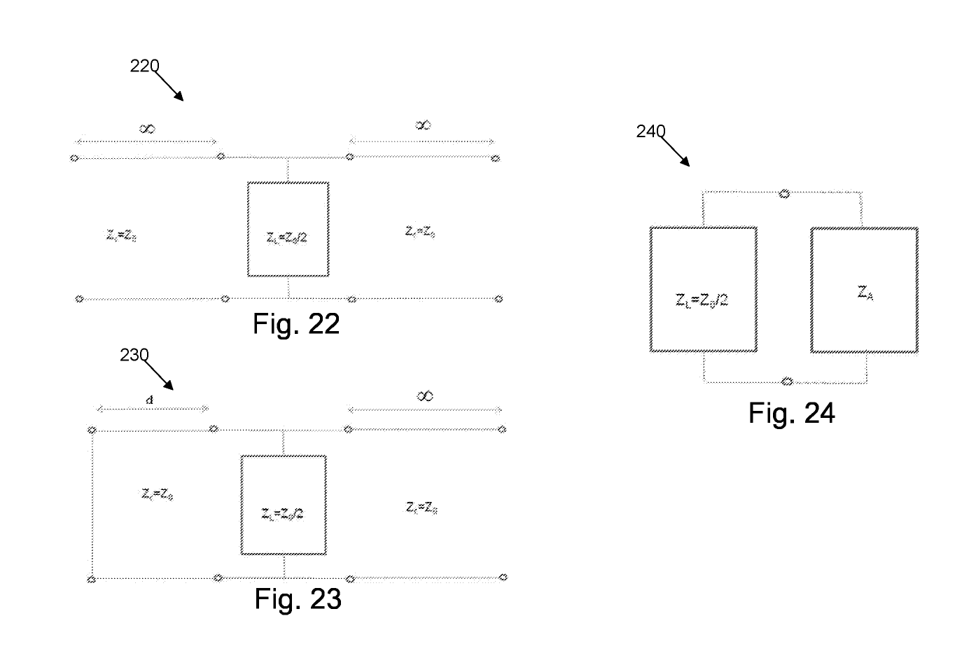

FIG. 22 illustrates an equivalent circuit representation 220 of the self-complementary array. This consists of a lumped-element impedance of Z₀/2 representing the feed region surface impedances and two transmission lines of characteristic impedance Z₀ representing plane-wave propagation on either side of the plane of the array. This representation implies that the array should efficiently transmit or receive energy to or from such waves when the array conductors are connected to small electrical circuits occupying the feed regions and having an internal load impedance Z_{L} of Z₀/2 ohms. Such circuits are also illustrated in FIG. 20 and FIG. 21.

FIG. 23 illustrates an approximate equivalent circuit 230 of the self-complementary array when placed a distance d from a conducting plane (groundplane) parallel to the array. This is similar to the circuit of FIG. 22, but has the transmission line representing the field on the groundplane-side of the array being of finite length d and terminated by a short circuit.

The total impedance connected to the load impedance in FIG. 23 is the parallel combination of the two impedances presented by the transmission lines. The can be denoted the antenna impedance and by solving the circuit of FIG. 24 this can be given by:

Z_{A}=(Z₀/2)×(1−exp(−j2kd))

where k=2π/λ is the propagation constant of plane waves in free space and λ is the corresponding wavelength. The definition of the impedance Z_{A} allows the circuit of FIG. 23 to be simplified to the circuit 240 as shown in FIG. 24.

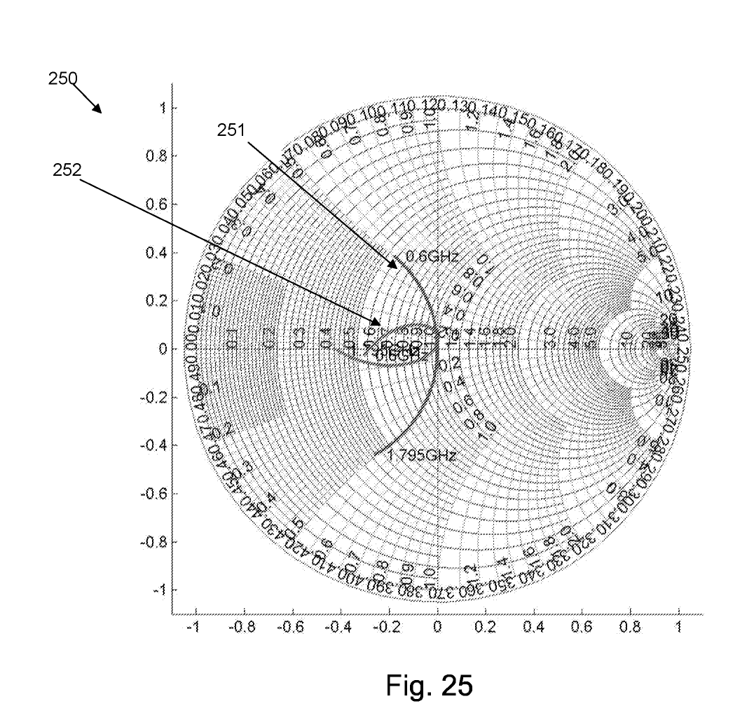

FIG. 25 illustrates the antenna impedance Z_{A} plotted 251 as a function of frequency on a Smith chart 250 where the reference impedance at the centre of the chart is Z₀. The antenna impedance is equal to Z₀ at a frequency f₀ where the distance d between the groundplane and the self-complementary array is equal to λ/4. The introduction of the groundplane causes the antenna impedance Z_{A} to vary with frequency and to be different from the load impedance Z_{L}. This impedance mismatch reduces the efficiency of power transfer from say an incident wave to the connected electrical load circuits. As shown in FIG. 25, at frequencies lower than f₀ the antenna impedance has an inductive reactance and at frequencies greater than f₀ the reactance of the antenna impedance is capacitive.

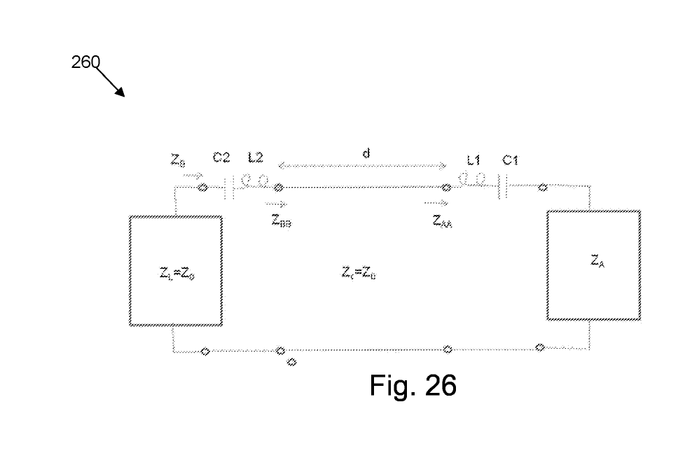

As shown in FIG. 26, the antenna impedance can be transformed so as to reduce the magnitude of the reactive component by adding a series capacitance C1 and a series inductance L1 to the antenna impedance. This combination of added series impedances adds capacitive and inductance reactance to the antenna impedance at frequencies below and above f₀ respectively. This thereby improves the impedance matching to the load circuit. The modified impedance is shown 252 obtained by the series combination of Z_{A} and the capacitance C1=0.9 pF and inductance L1=25 nH.

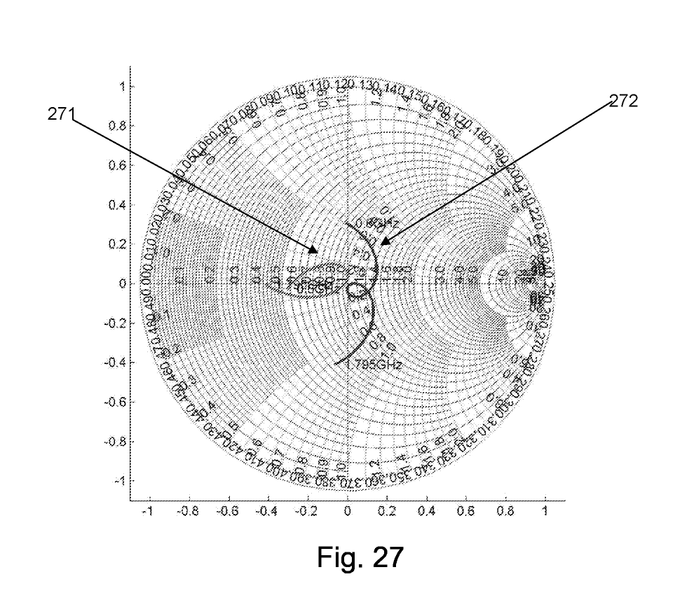

FIG. 26 illustrates the equivalent circuit of array antenna with feed conductor transmission lines of length d and series capacitive and inductive circuit elements inserted between the self complementary array and the load circuits. The load circuits are now at the groundplane and the impedance Z_{L} of the load circuits is increased from Z₀/2 to Z₀. As illustrated in FIG. 27, the feed conductors that divert the array signals to load circuits removed to the groundplane of the array can also be represented in the equivalent circuit by a transmission of length d. As shown in FIG. 27, the addition of this transmission line transforms the effective antenna impedance from Z_{AA} 271 to Z_{BB} 272.

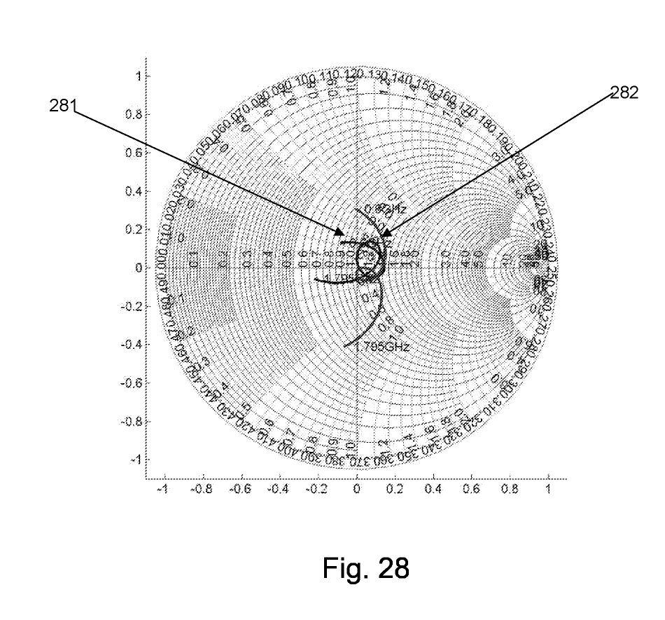

Illustrated in FIG. 28, the magnitude of the reactance of the impedance Z_{BB} (282) can be decreased by adding series capacitance C2 and inductance L2, giving the effective antenna impedance Z_{B} 281. The added capacitance and inductance predominantly add capacitive and inductive reactance at frequencies below and above f₀ respectively. Good matching to the load circuits is then obtained by increasing the load impedance Z_{L} so as to equal Z₀.

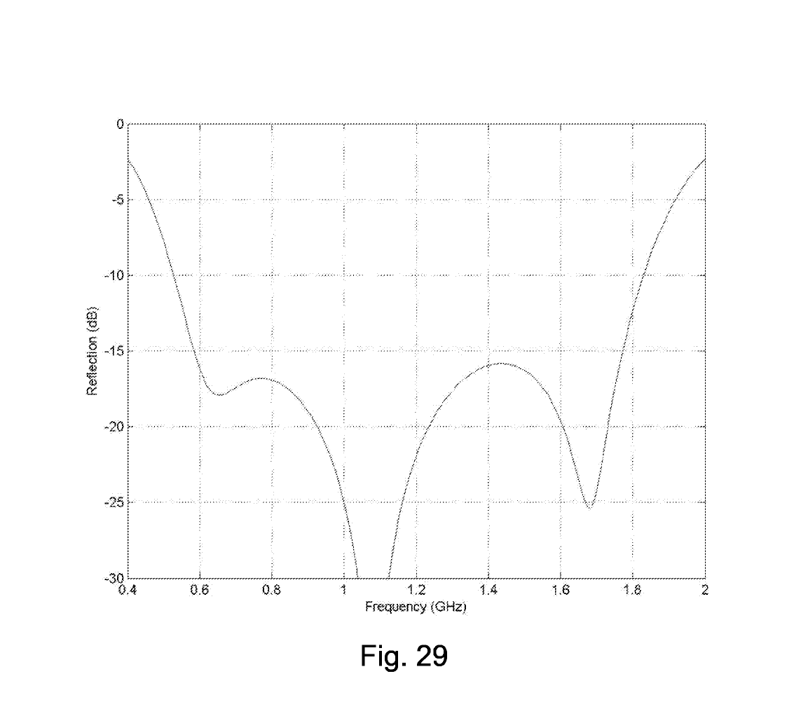

FIG. 29 illustrates the resulting reflection coefficient corresponding to the effective antenna impedance of FIG. 28.

It can be seen that through redesign of the array including matching impedances at low and high frequencies, improved results can be obtained.

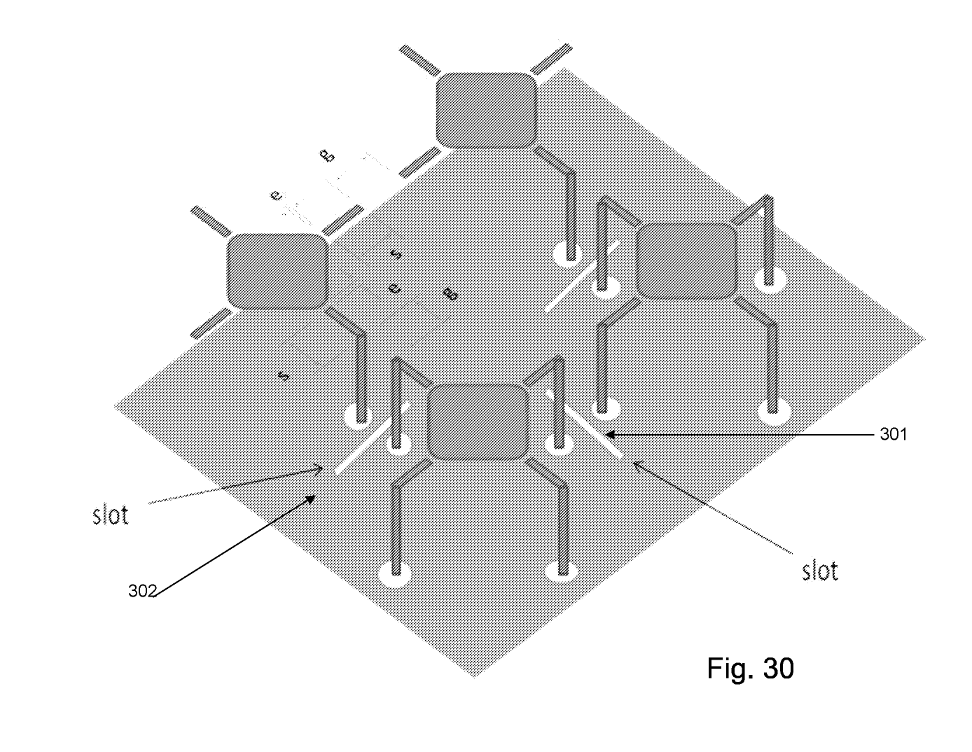

It will be evident that many variations are possible. For example, other techniques can be utilized to provide for implementation of series inductances etc. For example, instead of the slot approach of FIG. 17, slots or other modifications can be made to the ground plane. An example of a modified arrangement is illustrated in FIG. 30 wherein a series of slots 301, 302 are placed in the ground plane in order to provide a low loss series inductance in the equivalent circuit.

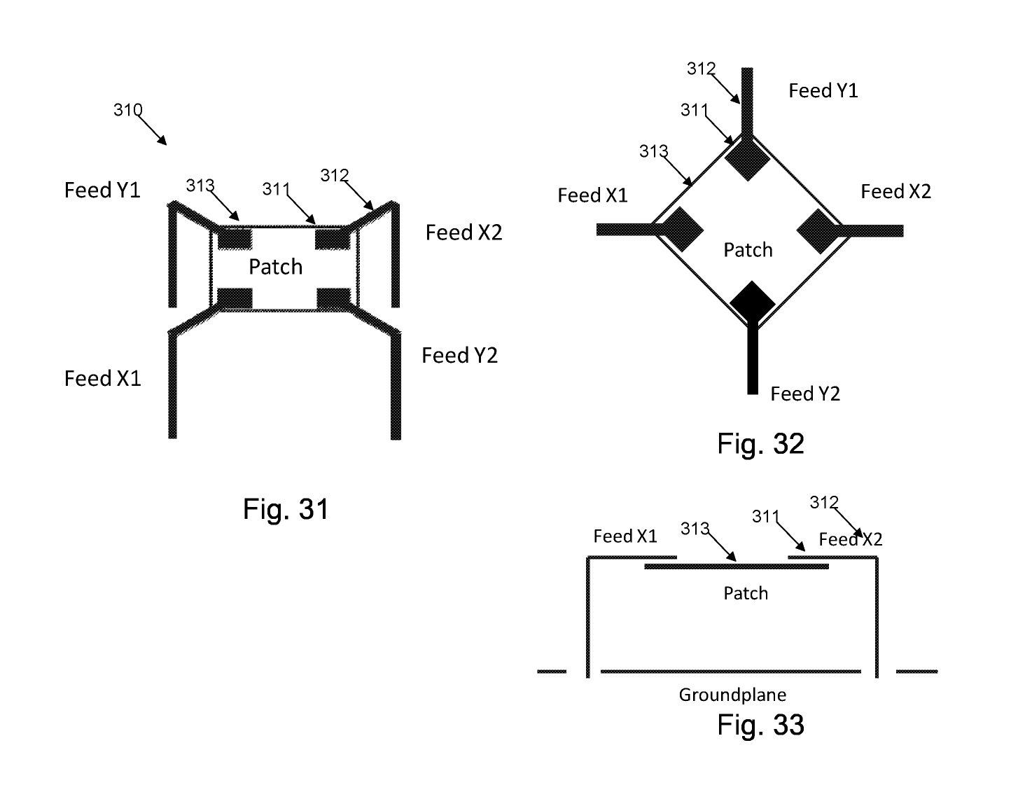

Further modified embodiments are possible. For example, depending on requirements, various modifications can be made to the patches and feed in arrangement to modify desirable impedance and capacitances in the series arrangement. For example, in FIG. 31, there is illustrated an alternative feed line and patch arrangement 310. In this arrangement, the patch 313 is electromagnetically coupled to a series of feeds e.g. 312. The thickness of each feed line is profiled via simulation to provide for a tunable inductance. The feed lines include a series of tabs e.g. 311, which are offset from the patches e.g. 313. The tabs provide for a selectively tunable capacitance between the tab and patch. Thorough extensive simulation, the size of the tabs can be adjusted to improve impedance matching properties. The tabs can be formed above (FIG. 33) or below the patches.

It will be understood that the advantages outlined in the antenna arrangement apply both in the transmission and reception operational modes.

### Interpretation

The following description and figures make use of reference numerals to assist the addressee understand the structure and function of the embodiments. Like reference numerals are used in different embodiments to designate features having the same or similar function and/or structure.

The drawings need to be viewed as a whole and together with the associated text in this specification. In particular, some of the drawings selectively omit including all features in all instances to provide greater clarity about the specific features being described. While this is done to assist the reader, it should not be taken that those features are not disclosed or are not required for the operation of the relevant embodiment.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. An antenna device including:
a first conductive extended body structure including a first surface;
a series of spaced apart conductive patches arranged substantially in the plane of a second surface offset from said first surface;
a series of conductive feed interconnections capacitively coupled to the spaced apart array of conductive patches,
said conductive feed interconnections being profiled to provide a complementary series inductance to said capacitive coupling so as to thereby improve the impedance matching of the conductive feed and conductive patches.

2. An antenna device as claimed in claim 1 wherein the antenna device operates over a predetermined frequency range and the reactance of the conductive feed and conductive patch interconnection is negative at low operational frequencies and positive at high operational frequencies and zero at an intermediate frequency.

3. (canceled)

4. An antenna device as claimed in claim 1 wherein said conductive feed interconnections are arranged into two sets of orthogonal polarizations for feeding corresponding conductive patches in a polarization orthogonal manner.

5. An antenna device as claimed in claim 4 wherein conductive feed interconnections from orthogonal polarizations are spaced apart when coupled to said patches.

6. An antenna device as claimed in claim 5 wherein the conductive feed interconnections of each set form a first and second grid with the first grid being offset relative to the second grid by substantially a half grid period.

7. An antenna device as claimed in claim 1 wherein the conductive feed interconnections include an elongated portion substantially parallel to the surface of any adjacent conductive patches and wherein said elongated portion is substantially in the same plane as the plane of the conductive patches.

8. (canceled)

9. An antenna device as claimed in claim 7 wherein said elongated portion includes a capacitive plate portion overlapping the conductive patch to provide controlled capacitive coupling thereto.

10. An antenna device as claimed in claim 9 wherein said capacitive plate portion comprises an end portion of the conductive feed.

11. An antenna device as claimed in claim 10 wherein said conductive feed interconnections are surrounded by a shield adjacent said first conductive extended body, said shield reducing the common mode current or enhancing the differential mode current of the conductive surrounded feed interconnections between the first surface and the conductive patches.

12. An antenna device as claimed in claim 11 wherein said shield is conductively interconnected to said first conductive extended body.

13-14. (canceled)

15. An antenna device as claimed in claim 1 wherein said conductive patches and said conductive feed interconnections are separated by a small non conductive gap.

16. (canceled)

17. An antenna device as claimed in claim 1 wherein said conductive feed interconnections form the closest electromagnetic coupling with the conductive patches at the corners of the conductive patches.

18. (canceled)

19. An antenna device as claimed in claim 1 wherein the effective length of the conductive feed interconnections is shortened by a conductive unit interconnected to said first conductive extended body structure in the area adjacent said first conductive extended body structure.

20. An antenna device as claimed in claim 19 wherein said conductive unit is of a generally boxed form having a slot in one surface thereof between said pairs.

21. An antenna device as claimed in claim 1 wherein said first conductive extended body structure includes a series of slots in the surface there of.

22. A method of designing an antenna array device, said device including a first conductive extended body structure including a first surface; a series of spaced apart conductive patches arranged substantially in a second surface offset from said first surface; a series of conductive feed interconnections electromagnetically coupled to the spaced apart array of conductive patches, the method including the step of:
(a) providing a conductive patch pattern that increases the conductive patch inductance in comparison with a checkerboard or self complementary array when said antenna array device is operated at frequencies greater than that at which the distance between the first and second surface is a quarter of the wavelength.

23-24. (canceled)

25. A method as claimed in claim 22 further comprising the step of:
(b) increasing the capacitance of the antenna array device when operated at frequencies lower than an equivalent frequency to the wavelength greater than the quarter wave distance between the first surface and the second surface.

26. A method as claimed in claim 25 wherein said capacitance is increased by the interconnection of a capacitive device between predetermined conductive patches and corresponding conductive feed interconnections.

27. A method of suppressing the amount of common mode current in an antenna array device, said device including a first conductive body structure including a first surface; a series of spaced apart conductive patches arranged substantially in a plane of a second surface offset from said first surface; and a series of conductive feed interconnections electromagnetically coupled to the spaced apart array of conductive patches, the method including the step of:
suppressing the common mode current by shielding said conductive feed interconnections in the vicinity of said first conductive body structure sheet.

28. A method as claimed in claim 27 wherein said shielding includes a conductive shield conductively interconnected to said first conductive body structure.

29. (canceled)
